(19) United States
(12) Patent Application Publication
(10) Pub. No.: US 2008/0199692 A1
(43) Pub. Date: Aug. 21, 2008

(54) Adhesive Safety Strap and Method for Its Production

(76) Inventors: Ulrich Wesselmann, Gluecksburg (DE); Thomas Mangols, Erfurt (DE); Edo Kuntzsch, Erfurt (DE)

Correspondence Address: DUANE MORRIS LLP;PATENT DEPARTMENT, 1540 BROADWAY, NEW YORK, NY, 10036-4086, US

(21) Appl. No.: 12/059,658

(22) Filed: Mar. 31, 2008

(30) Foreign Application Priority Data
Feb. 4, 2007 (DE) DE 102007016483.3

(51) Int. Cl. B32B 7/12

(52) U.S. Cl. 428/343

(57) ABSTRACT

The invention relates to an adhesive safety strap 1 and a method for its production, wherein a given length is separated from an adhesive packaging band with a carrier layer 2 made from a material that can be processed with a laser and an adhesive layer 3, in order to form an adhesive strap; and a slot geometry, which cuts completely through the carrier layer 2, is formed in this adhesive strap by means of a laser after being attached to a package, wherein this slot geometry is defined by one or more slots 5 of a given profile and a width defined by the material removal, and also optionally by their relative arrangement.

### FIELD OF THE INVENTION

The invention relates to an adhesive safety strap, which undergoes, at the latest, after detachment from a surface, particularly a paper or cardboard surface, irreversible, visually detectable changes for its reattachment.

### BACKGROUND OF THE INVENTION

An adhesive strap is basically used for connecting two pieces of a flat material, where each end of the strap is affixed to one of the pieces. An adhesive strap that cannot be manipulated without being noticed shall be designated below as an adhesive safety strap. It is especially suitable as an anti-theft safety device for wrappings (also called packaging below) formed from the combination of a plurality of individual packages, for example, shipping packages for cigarette cartons, small electronic devices, and pharmaceutical products.

In order effectively to form a seal for packages that is safe from manipulation, particularly paper or cardboard packages, the adhesive safety strap must be affixed to at least two abutting or overlapping packaging parts in such a way that the removal of at least one of the packaging parts is necessary to be able to open the packaging.

Adhesive bands of suitable length for sealing a package shall be designated herein as an adhesive strap.

From the prior art, a plurality of self-adhesive bands or adhesive labels are known, which undergo visible, irreversible changes due to their special layer structure when they are manipulated, i.e., when an attempt is made to detach them from the package. Such specially manufactured adhesive bands and adhesive labels are not, in practice, readily available, so that they also cannot be replaced without being noticed.

JP-A-09-176990 discloses, for example, an adhesive band, which is made from a pigment-containing layer with an adhesive component and a protective layer located above the pigment-containing layer. When the adhesive band is peeled away, the protective layer is completely peeled away, but the adhesive layer remains affixed partly to the protective layer and partly to the packaging, i.e., the pigment-containing layer is visibly damaged and subsequent reattachment of the layer can be clearly recognized. A disadvantage here is the necessity of special adhesives that must be introduced into the pigment-containing layer.

DE 299 13 746 U1 describes a layer structure for an adhesive label made up of an intermediate layer of an adhesive layer provided with weakening lines and a continuous top film, which is applied to the intermediate layer provided with weakening lines by means of adhesive. The top film holds the label parts together and a smooth surface that can be easily printed on is produced. Through careful detachment of the top layer, which carries the identification mark, it is possible to reattach it somewhere else and thus to place the label illegally.

DE 103 46 683 A1 describes an adhesive label made up of an adhesive layer and a film reduction structure with at least one layer that is scored but not cut through by means of a laser beam. Suitable for this structure is a polyester film, which features tear strength and heat stability sufficient to keep the film structure stable.

The material of the film layer bordering the adhesive layer and the adhesive are selected in such a way that the adhesive label can be repositioned preferably after approximately half an hour. The degree of weakening of the weakening line, i.e., specifically, the material-reduction depth, is dependent on the material and its thickness in such a way that the adhesive label can be applied to the object to be labeled without risk of destruction, the repositioning of adhesive label being guaranteed without damaging it, and after complete application of the adhesive layer, the adhesive label rips in an uncontrollable way in the region of the weakening line if an attempt is made to remove the adhesive label.

In a preferred embodiment of the film structure, in addition to the film layer that can be weakened by laser radiation, a laser-sensitive layer can be provided. In this way, advantageously, a weakening line in the film layer that can be weakened and also writing in the laser-sensitive layer can be realized in a single processing step.

An adhesive label according to DE 103 46 683 A1, which can be used both as an identification mark and a safety seal, must have, as explained, a special film structure of at least two layers or, in the case of only one layer, an identification mark can be realized only through an additional printing step.

All of the adhesive bands and adhesive labels described above have the common feature that they are constructed in such a way that they undergo irreversible changes when an attempt is made to detach them, so that the same adhesive band or adhesive label is not suitable for resealing in an unnoticeable way and an equivalent adhesive band or adhesive label is not readily available as a replacement due to the special layer structure.

### SUMMARY OF THE INVENTION

The invention is based on the problem of devising a method for producing an adhesive safety strap made from a commercially available, self-adhesive packaging band and also a non-reusable adhesive safety strap.

This problem is solved by the method having the features of Claim 1 and by the adhesive safety strap having the features of Claim 6.

Advantageous refinements are described in the subordinate claims.

### BRIEF DESCRIPTION OF THE DRAWINGS

The adhesive safety strap will be explained in more detail below in the form of an example with reference to the drawings in which:

FIG. 1 is a section diagram through an adhesive safety strap affixed over two packaging parts,

FIG. 2a shows an adhesive safety strap according to FIG. 1 in top view with a slot geometry made from zigzag lines,

FIG. 2b shows another embodiment of an adhesive safety strap in top view with a slot geometry made from barcode lines.

### DESCRIPTION OF AN EMBODIMENT

Basically, an adhesive safety strap 1 is made from a piece of a commercially available adhesive packaging band with a carrier layer 2 made from a material that can be processed with a laser and an adhesive layer 3 formed to a length suitable for affixing it over two packaging parts 4a, 4b of one package, which abut or overlap each other, such as, e.g., two opposing flaps on one side of a carton.

In the carrier layer 2, there is at least one slot 5 of constant width cutting completely through the carrier layer 2.

The slot 5 can be open on both sides, wherein the adhesive safety strap 1 is divided into several parts.

Likewise, the slots 5 can be closed on one or both sides, whereby the parts of the adhesive safety strap 1 bordering the slot 5 remain connected to each other.

Advantageously, the slots 5 can be formed running along lines whose profiles represent an identification mark, e.g., a writing or a barcode.

The slots 5 are formed by means of a laser scanner, wherein the process parameters are set in such a way that the slots 5 are produced with a one-time scanning in a given slot profile and feature a width that makes the slots 5 visually and/or tactically detectable in the surface structure of the carrier layer 2. It is clear to someone skilled in the art that generating the slots 5 is also possible by guiding a laser head along the slot profile.

Likewise, the packaging could be moved relative to a stationary laser head, in order to create the necessary relative movement, with a given advancing speed, between the tool (laser beam) and workpiece (packaging with adhesive safety strap).

The slot profile and the slot width of the slots 5 form a reproducible slot geometry.

This must be maintained in order not only to be able to detect the slots 5 and optionally to be able reliably to identify an identification mark defined by the slot geometry, but also to be able to recognize tampering from visually and/or tactically detectable changes to the slot geometry.

An identification mark can be formed that is visually and/or tactically detectable. Advantageously, an identification mark is selected that is indeed detectable but not identifiable without aids, e.g., a barcode, which makes an attempt to forge the identification mark more difficult.

By forming a slot geometry in the adhesive safety strap 1 before application, it cannot be guaranteed that the slot geometry will remain unchanged during the application. Even the slight expansions to which the adhesive safety strap 1 is subject during application or a non-uniform pressure on the packaging parts 4a, 4b can lead to temporary changes in the slot geometry, especially the width of the slots 5, which are fixed upon application, due to warping of the adhesive safety strap 1.

For this reason, the adhesive safety strap 1 is first positioned at its proper location and then slots are formed with a laser.

Expansions of the adhesive safety strap 1 during the application and also possible deformations thus have no effect on the slot geometry.

After the slot geometry is formed, if the adhesive safety strap 1 is not manipulated, the slot geometry remains permanently unchanged.

If an attempt is then made to remove the adhesive safety strap 1 without damaging it, which is perhaps possible with the greatest care, it can nevertheless not be used in an unnoticeable way, because the slot geometry cannot be produced identically again.

Forging a new adhesive safety strap 1 is also practically impossible. The material structure for the adhesive safety strap 1 could indeed be realized since it was made from a piece of a commercially available adhesive packaging band, but the formation of an identical slot geometry requires not only the necessary technology, specifically, a laser scanner, but also its control to generate the identical slot geometry.

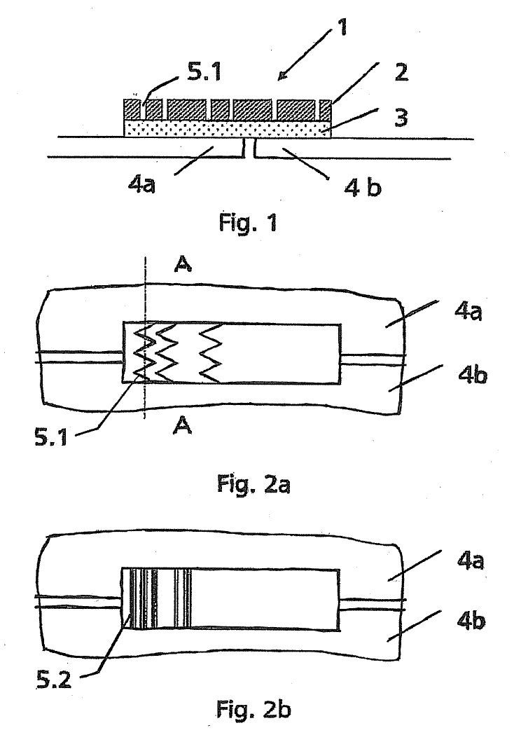

In one advantageous embodiment of the adhesive safety strap 1, shown in FIGS. 1 and 2a, an adhesive packaging band was used with a carrier layer 2 made from polypropylene with a rubber component and an adhesive layer 3 made from acrylate.

The slot geometry is formed by three slots 5.1 arranged one next to the other and extending over the width of the adhesive safety strap 1 in the form of zigzag lines. Through this slot geometry, the adhesive safety strap 1 is formed from four separated parts. Even if it should be possible to remove the individual parts without damage from the surface of the two packaging parts 4a, 4b, they could not be placed again in such a way that the slots 5.1 form an identical slot geometry. In particular, the two intermediate parts each delimited by the zigzag lines are not mounted past their non-expanded length due to the accordion effect.

In FIG. 2b, another advantageous slot geometry is shown. It is formed by a plurality of different, straight-line slots, which are spaced apart in a defined way and which, in connection, represent a barcode.

The individual parts of the adhesive safety strap 1, which can possibly be detached without damage, could indeed be reattached over an identical length, but replicating the given width is not possible.

As a rule, the parts of the adhesive safety strap 1 that have been separated or that are still connected to each other cannot be detached without over-stretching the carrier layer 2. Even slight over-stretching results in the, practical and theoretical, impossibility of the adhesive safety strap 1 being re-positioned with its original slot structure.

For producing an adhesive safety strap 1, a length that determines the length of an adhesive strap is separated from an adhesive packaging band with a carrier layer 2 made from a material that can be processed with a laser and an adhesive layer 3 suitable for sealing packages made of paper or cardboard.

The adhesive strap is then affixed over at least two packaging parts 4a, 4b of a package in such a way that the package can be opened without damage only when the adhesive strap is removed from at least one of the packaging parts 4a, 4b. After application, one or more slots 5 cutting completely through the carrier layer 2 are formed in the carrier layer 2 by means of a laser. The slots 5 form a defined slot geometry through their profile and width and also, optionally, their relative arrangement. The slots 5 are formed by a one-time relative movement between the laser beam and the adhesive strap that describes the slot geometry, by which means an adhesive safety strap 1 is formed from the adhesive strap.

Advantageously, a continuous-wave CO₂ laser can be used.

It is clear to someone skilled in the art that the slot geometry can also be generated by several lasers and the relative movement can also be a combined movement of the laser and the package. Preferably, the relative movement is generated merely through a controlled scanning movement of the laser. The process parameters, in particular, the laser output, the scanning speed, and the advancing speed are selected so that the carrier layer 2 is completely cut through by a single pass over the slot structure, but simultaneously the packaging parts 4a, 4b located underneath remain undamaged.

Other plastics, such as PVC or polyester, as well as paper, can be used as additional materials for the carrier layer 2, which advantageously feature a rubber component.

For the adhesive layer 3, in particular, hot-melt adhesives are suitable.

The carrier layer 2 and the adhesive layer 3 can also be configured in such a way that they form an adhesive packaging band, which is a wet adhesive band.

### LIST OF REFERENCE SYMBOLS

1 Adhesive safety strap

2 Carrier layer

3 Adhesive layer

4 a, 4b Packaging parts

5 Slot

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modification as are suited to the particular use contemplated.

1. A method for producing an adhesive safety strap comprising, separating a given length from an adhesive packaging band, said band having a carrier layer made from a material that can be processed with a laser and an adhesive layer, thereby forming an adhesive strap that can be affixed to a package, forming by means of a laser at least one slot which cuts completely through said carrier layer, said slot having a geometry defined by a given profile and width defined by the material removal.

2. The method according to claim 1, wherein said adhesive packaging band is a commercially available adhesive band provided for sealing packages made from paper or cardboard.

3. The method according to claim 1, wherein said carrier layer is paper.

4. The method according to claim 1, wherein said carrier layer is a plastic.

5. The method according to claim 1, wherein said carrier layer has a rubber component.

6. The method according to claim 1, wherein a plurality of slots is formed by means of a laser, said slots cutting completely through said carrier layer, the geometry of said slots defined by the arrangement of the slots of said plurality relative to each other.

7. An adhesive safety strap comprising, a length of an adhesive packaging band including a carrier layer made from a material having a rubber component and an adhesive layer, and at least one continuous slot formed in said carrier layer wherein said slot has a given slot geometry defined by a given profile and width, said profile and width defined by the material removal, and by the arrangement of said slot which divides the adhesive safety strap into segments.

8. The adhesive safety strap according to claim 7, wherein said segments are completely separated from each other so that they can be detached from a surface only individually.

9. The adhesive safety strap according to claim 7, wherein said slot geometry represents an identification mark.

10. The adhesive safety strap according to claim 9, wherein said identification mark is not visually identifiable, thereby making forgery more difficult.

11. The adhesive safety trap according to claim 7, wherein said carrier layer is paper.

12. The adhesive safety strap according to claim 7, wherein said the carrier layer is plastic.

13. The adhesive safety strap according to claim 7, wherein said adhesive packaging band is a commercially available adhesive band for sealing packages made from paper or cardboard.

14. The adhesive safety strap according to claim 6, wherein said carrier layer has a plurality of slots each having a profile and width defined by the arrangement of said slots relative to each other.

15. The adhesive safety strap according to claim 14, wherein the width of each slot of said plurality of slots is constant, whereby a change in the width due to manipulations of the adhesive safety strap is more easily detectable.
